(19) United States
(12) Patent Application Publication
(10) Pub. No.: US 2002/0038270 A1
(43) Pub. Date: Mar. 28, 2002

(54) Method for transacting publicly-subscribed culture stocks via the internet for public offering of investment in production of cultural and artistic activities

(76) Inventors: Jae Hong Shin, Seoul (KR); Tae Min Oh, Seoul (KR)

Correspondence Address: JACOBSON HOLMAN PLLC, 400 SEVENTH STREET N.W., SUITE 600, WASHINGTON, DC, 20004, US

(21) Appl. No.: 09/736,133

(22) Filed: Dec. 15, 2000

(30) Foreign Application Priority Data
Aug. 7, 2000 (KR) 2000-31091
Sep. 16, 2000 (KR) 2000-52325

(51) Int. Cl. G06F 17/60

(52) U.S. Cl. 705/36

(57) ABSTRACT

The present invention provides a method for transacting publicly-offered culture stocks using the internet, having a membership obtainment step for transactions, a public offering step and a stock listing step. The method includes a membership obtainment step for providing a member with an internet transaction account by which the member can make an investment and a purchase; a public offering and examining step wherein an examining group including an insurance company determines whether a work requested by a public offering requester will be publicly-offered, and insurance rates are determined; a public offering step for requesting the public offering of the examined work via an internet stock exchange market for publicly-subscribed culture stocks and for being covered by insurance; a listing step for listing the publicly-subscribed culture stocks of the publicly-offered work on a stock market in the internet stock exchange market at the end of a public offering term; a transaction step for transacting the listed, publicly-subscribed culture stocks until settlement of accounts, after listing of the stocks; and a distribution step for distributing the full profit, after the settlement of accounts.

### BACKGROUND OF THE INVENTION

The present invention relates to a method for inviting and transacting publicly-subscribed culture stocks in their stock exchange market via the internet, wherein sufficient funds are provided to the producers by efficiently inviting via the internet the public's investments in production of cultural and artistic activities such as the production of movies, acts and sound tracks or their planning of performances, while the profits proportional to the public's investments are efficiently distributed to the individual investors.

Generally, activities such as the production of movies and the planning of public performance of operas are carried out by the investment of some gigantic capitalists. In this case, it is difficult for the authors' originality and artistic characteristics to be sufficiently displayed in their works, since substantial production processes for the works are not accomplished independently from the gigantic commercial capitalists.

Recently, the number of movie agencies, which publicly inform the movies via their internet homepages and invite the public's investments through the public offering in their internet homepages, increases. It helps to have an effect on their commercial business as a publicity before screening of the movies, but it is difficult to be regarded as a substantial economical activity. That is, in the case of the invitation of funds through the aforementioned public offering for use in publicity, extremely small portions of the production costs are publicly-offered to the general investors. Thus, the fact is that it is a simple publicity which is not worthy of economical investment, although it has a form of “investment” such as the public offering.

There is another method for inviting the public's investment by attracting their attention to special persons such as famous actors, famous movie producers, etc. who are advantageous in the commercial business. In case of such a kind of public offering, since the public offering is based on not the work publicly-offered but the popularity of the actors or producers, the investment may be made without objective grounds for deciding the final works. Further, the investing manner is such that the investor can take part in the public offering only by showing their intention of participating and depositing the money into the specific account if their focus of interest is approved. Thus, it cannot be regarded as an economical activity in view of a social aspect since the profits proportional to the investment cannot be distributed until performance, purchase, etc. of the movies are completed and since economical activities such as additional transactions of invested bonds after public offering cannot also be carried out.

Therefore, in the investment according to the conventional public offering as mentioned above, it is difficult to convert the investment into money before distribution of the profits and to freely carry out the additional economical activities, that is, the purchase of the invested interests. In other words, according to the conventional method for public offering, the investment by the public is accomplished in a state that estimation of the object to be invested by the investors is not precisely confirmed, since the public has difficulties in making an objective estimation of the movies, which is useful in the investors' selection, before and after their investment in the publicly-offered movies. Furthermore, since transaction manners according to the conventional method are not specific and systematic, it is difficult that further transactions occur during the period from a time of the investment to a time of the profit distribution and where activation of the transactions cannot be attained continuously.

### SUMMARY OF THE INVENTION

Therefore, the object of the present invention is to provide a method for transacting publicly-subscribed culture stocks via the internet and a system for implementing the method, wherein configuration in which the investors can directly and objectively determine cultural and artistic activities through the internet is provided and participation in the public offering can be made based on the results of the determination.

Another object of the invention is to provide a method for transacting publicly-subscribed culture stocks via the internet and a system for implementing the method, wherein further economical activities can be actively made after participation in the public offering.

To achieve the above objects, the internet stock exchange market for transacting publicly-subscribed culture and art stocks according to the present invention transacts registered bonds—e.g., publicly-offered movie and event stocks—in various forms other than a form of general bearer bonds and supplies, as assets (bonds), operating and investing funds required for production of the work other than the funds for managing the corporations. All the issued bonds become the objects to be transacted. Further, the data for objectively deciding the objects to be invested are provided in the internet stock exchange market. The total amount of profits are shared when distributed, wherein the transaction becomes terminated. In the meantime, the additional profits, if any, occurred after the transaction will be shared again.

Since the producers procure the expenses such as costs for production of and publicity of the work by means of the transacting bonds in the internet stock exchange market while producing the work, they can always do their business. Further, more profits can be provided to the investors since the expenses, which are reinvested into the company and subtracted from the profits, are reduced.

The method for transacting publicly-offered culture stocks in the internet stock exchange market for publicly-subscribed culture stocks includes a membership obtainment step for providing a member with an internet transaction account by which the member can make an investment and a purchase; a public offering and examining step wherein an examining group including the netizens and persons in charge at the internet stock exchange market and a professional examining group including professionals in the same business world and an estimation group of an insurance company determine whether a work requested by a public offering requester (producer) will be publicly-offered, and insurance rates for the work are determined; a public offering step for requesting the public offering of the examined work via the internet stock exchange market; a listing step for listing the publicly-subscribed culture stocks of the publicly-offered work on a corresponding stock market (for example, movie-stock market, etc.); a transaction step for transacting the listed, publicly-subscribed culture stocks until settlement of accounts, after listing of the stocks; a step for distributing profits or requesting the supply of insurance money for a financial loss, after the settlement of accounts; and a distribution step for distributing a further profit after the distribution of the settled profit.

### BRIEF DESCRIPTION OF THE DRAWINGS

FIG. 1 is a flowchart showing a step of registering a membership and connecting to a main frame according to the present invention.

FIG. 2 is a flowchart showing a step of requesting the public offering by the requester according to the invention.

FIG. 3 is a flowchart showing a step of subscribing for the public offering by the subscriber according to the invention.

FIG. 4 is a flowchart showing a step of offering the publicly-subscribed movie stocks and listing the stocks on a movie stock market.

FIG. 5 is a flowchart showing a step of listing the movie stocks that are not publicly-subscribed.

FIG. 6 is a flowchart showing a step of transacting the movie stocks that are listed on the movie stock market.

FIG. 7 is a flowchart showing a process of distributing profits after the settlement of accounts according to the invention.

### DESCRIPTION OF THE INVENTION

Hereinafter, preferred embodiment of the present invention will be explained in detail with reference to the accompanying drawings.

An embodiment of the present invention relates to publicly-subscribed movie stocks via an internet stock exchange market for the publicly-subscribed culture stocks during the production of cultural and artistic activities.

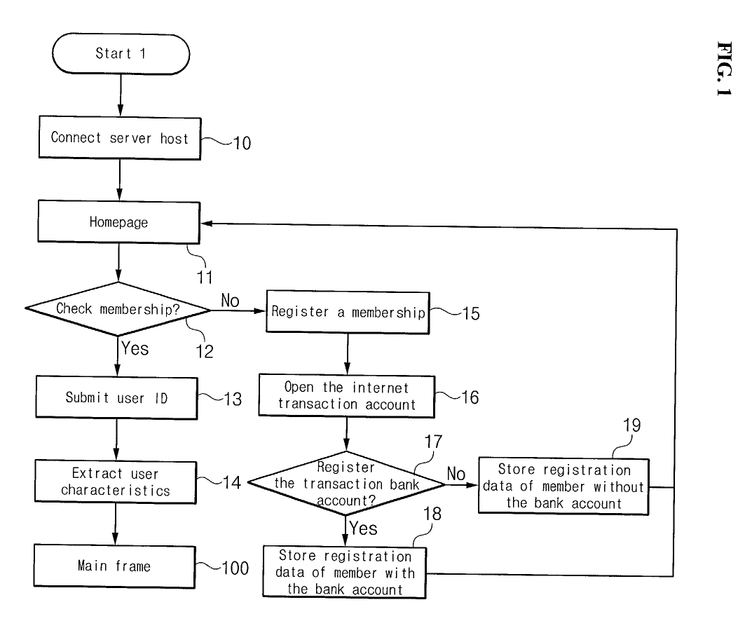

FIG. 1 shows a step of registering a membership in order to utilize the internet stock exchange market for the publicly-subscribed culture stocks.

The membership registration step of the invention is similar to that of the conventional art, but is different from that of the conventional art in that it provides each of the individual members with an internet transaction account capable of investing and shopping through the internet. The internet transaction accounts commonly now used are categorized into two different accounts, one for use in the investments only such as general stock trading and another for use in the purchases only such as shopping. That is, two different kinds of the above conventional transaction accounts cannot be interchanged in view of fund utility, and have been used only for the transaction using point accumulation system and a contract between internet sites (service suppliers). On the contrary, the internet transaction accounts of the present invention comprises of an investment account which is registered into a registered correspondent bank (block 17) in order to transfer the funds at the time of the public offering (block 301), a transaction (block 501) and a profit distribution (block 602) which will occur later; and a purchase account for use in encashment of the fund itself which is transferred from the account of the registered correspondent bank. Thus, in the present invention, the transacted amount of money used for internet shopping can be paid and bi-directional usage for both investment and purchase can be obtained. Accordingly, the present invention comprises the accounts used for perfect electronic commercial transactions.

In the meantime, at the time of initial membership registration, admission and subscription can be made through payment processes such as giro, etc. instead of the registration into the bank (block 17). As described above, however, the registration into the bank (block 17) must be accomplished for the purpose of the fund transfer which will occur later. The registered members in accordance with the above manner are divided into two groups of members, that is, one group of members (18) having bank accounts and another group of members (19) without having bank accounts, and stored into a main server of the internet stock exchange market.

In the membership registration step, the following data are used as a database:

Full name (real name) and Resident registration number

ID and Password (A subscriber's code in the form of numbers is used as ID and a combination of the English characters and the numbers are used as the password.)

Occupation

Address and E-mail address

Bank Name and Account number thereof

Telephone number and Mobile phone number

Together with a database which will be later examined by the netizens, age and gender obtained from the resident registration number and occupation are used as data for determining whether the movies, publicly-subscribed and produced later, will be successful in their business performance.

As shown in FIG. 1, individual peculiarities of users as registered members are extracted from the ID used in connection with the internet stock exchange market. The users are largely divided into two kinds of investors and requesters for the public offering (producers), and acquire the information prerequisite to each kind. For example, data for estimating the movies now publicly-subscribed, information on the movies now examined for the public offering, and information (current price, volume of transaction, etc.) on the publicly-subscribed stocks before and after the listing are provided to the investors, while information on the procedures for requesting the public offering, information on the examination particulars for the public offering, etc. are provided to the requester.

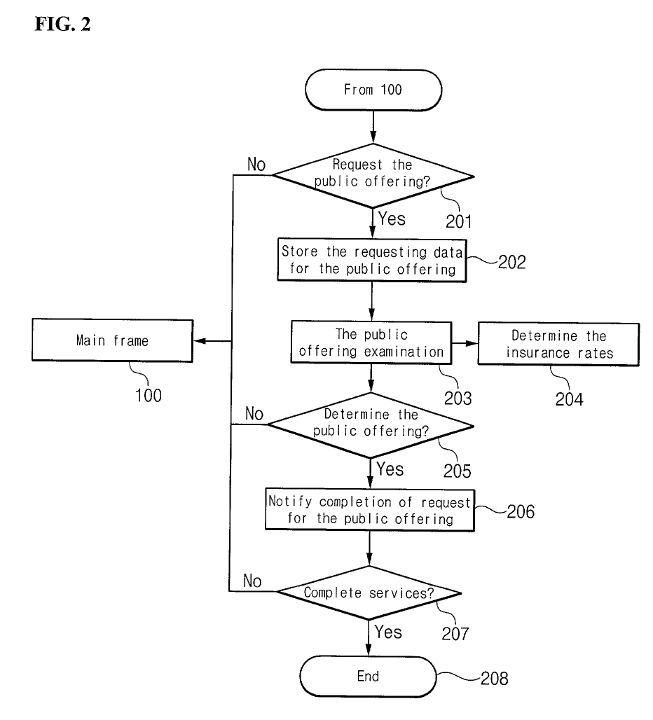

In the meantime, the main frame shown in FIG. 1 means that it includes a site for the publicly-subscribed stocks which is provided from the internet stock exchange market, and the homepage exclusively used for the members which is capable of connecting to the internet commercial transaction site. The internet transaction site comprises the steps (201-207) of requesting the public offering, the steps (301-313) of subscribing for the public offering, and the internet transaction steps (401-700) having the steps (410-412) of listing the stocks subscribed without the public offering. The main frame and information thereon provided to the members are different from those provided to the non-members. The aforementioned steps will be described with reference to FIGS. 2 to 7.

FIG. 2 shows that the requester enters into the step of requesting the public offering, according to his peculiarities obtained when the requester for the public offering is connected to the main frame.

As described above, the requester as a registered member can submit the plan for cultural and artistic activities such as the movies, sound tracks, events, etc., which the requester intends to produce via the internet stock exchange market, at the time of requesting the public offering (block 201). This connection of the requester is terminated at the step of requesting the public offering. The offered plan is stored into the main server of the internet stock exchange market (block 202). The plan is also subjected to examination of the insurance company and the examining group comprised of the netizens and the persons in charge via the internet (block 203), and thus, the insurance rates occurred later are determined (step 204). In this case, the insurance company can obtain both the increase of business performance and enlargement of the investment by taking advantage of culture promotion funds which should be paid by the company. Further, since the insurance company takes part in the examination of the public offering (block 203), individual investors (hereinafter, referred to as “investors”) can acquire more objective information and determine the insurance rates which will be applied to future insurance contracts (block 204). Thus, unnecessary time required for future supply of the insurance money (block 609) can be reduced. All the steps in the examination of the public offering are represented as the results of real-time summation and average thereof, and the results are automatically calculated as estimation standard values in a real time by the main server of the stock exchange market. The plan determined (block 205) for public offering through the public offering examination (block 203) is used as data for future public offering. If the internet stock exchange market informs the person requesting the public offering that the public offering is completed (block 206), the step of requesting the public offering is completed (208).

The request of the public offering can be made for domestic movies, unreleased or being produced, and foreign movies, already produced and being imported, as well as new movies.

The detailed descriptions on the examination (203) of the public offering is as follows:

The examination (203) of the public offering is carried out through the internet and includes the following three stages:

1. The Examination Stage by the Netizens

The examination by the netizens is accomplished in a manner that the homepage of the internet stock exchange market provides the members or general netizens with predetermined data and represents the analysis results of the data as a probability. The data provided to the netizens are as follows.

A scenario abstract

Staffs such as directors, actors, etc.

Background music

The member of the staff among the prepared data can be further subdivided, and the netizens' decision on subdivided items is simply made by the standard values in the form of “O-X” type or “High-Medium-Low” type. In the case of the “O-X” standard values, the respective answers are accumulated in the form of one-bit type, T(true) and F(false) and represented as a percentage. Further, the results by the netizens correspond to about 30% of total examination standards. Furthermore, age and gender of the netizens as an examining group can be divided into some groups and be utilized for the data of the market survey occurring later.

The examination stage by the general netizens comprises the steps of connecting to the homepage of the internet stock exchange market, selecting the movies to be estimated, clicking the standard values (“O-X” or “High-Medium-Low”) provided for the selected movies, collecting the clicked estimation standard values according to respective estimation fields, and representing as a percentage the ratio of the examination standard values by the netizens to respective collected standard values according to the respective estimation fields.

The examination stage by the members of the internet stock exchange market comprises the steps of connecting to the homepage of the internet stock exchange market, carrying out log-in with predetermined ID and password, introducing into a main frame, selecting the movies to be estimated, clicking the standard values (“O-X” or “High-Medium-Low”) provided for the selected movies, collecting the clicked estimation standard values according to respective estimation fields, and representing as a percentage the ratio of the examination standard values by the netizens to respective collected standard values according to the respective estimation fields. However, subdivision of the data and estimation items provided to the members may be different from those of the general netizens. Thus, more accurate standard values can be pursued since unreasonable factors such as redundant examination are eliminated.

2. The Examination Stage by the Stock Exchange Market

The extent of data now provided differs after the examination stage by the netizens. As shown in Table 1, the prepared data is divided into nine examined items, and examination results of the respective items are given in the form of proportional numbers for indicating five grades. All information accompanied therewith is composed of internet languages and estimated through the internet based on the planned proposal which is submitted by the person requesting the public offering. Table 1 shows examined items and estimation weighing factors thereof.

The proportional numbers for indicating five grades with respect to the provided, examined items are determined by the examining group in the internet stock exchange market through the internet. The proportional number determined in each item is calculated along with the weighting factor for each item shown in Table 1, so that the final result value for each examined item is obtained. The examined result value in the internet stock exchange market determined as such is applied as about 20% with respect to the final estimation standard.

TABLE 1

| Examined Item | Weighting factor |
|---|---|
| Scenario | 4 |
| Director | 3 |
| Leading Actor | 3 |
| Other Actors | 2 |
| Producer | 2 |
| Music | 2 |
| Production Costs | 2 |
| Filming | 1 |
| Other Staff | 1 |
| Total Marks | 20 |

The examined items shown in Table 1 include nine items. Assuming that the total estimation marks of the movie requested to be examined is given 20 points as full marks, the weighting factors on the right-hand side of the examined items designate distribution of marks of each item with respect to the total estimation marks. In the case of the internet stock exchange market, the estimation marks for each item, which is designated by the five-grade, proportional number (0.2, 0.4, 0.6, 0.8, or 1.0), is calculated along with the weighting factor so that the examined result value is designated by a percentage of the total estimation marks. Table 2 exemplifies one example thereof.

TABLE 2

| | Weighting | Proportional | Examined |
|---|---|---|---|
| Examined Item | factor | Number | Value |
| Scenario | 4 | 0.8 | 3.2 |
| Director | 3 | 1.0 | 3.0 |
| Leading Actor | 3 | 0.6 | 1.8 |
| Other Actors | 2 | 0.6 | 1.2 |
| Producer | 2 | 0.4 | 0.8 |
| Music | 2 | 0.8 | 1.6 |
| Production Costs | 2 | 0.8 | 1.6 |
| Filming | 1 | 0.6 | 0.6 |
| Other Staff | 1 | 0.6 | 0.6 |
| Total Marks | 20 | | 14.4 |

As seen in Table 2, the examined result value of the publicly-offered movie, for example, was estimated as 14.4 which is then converted into 72 points in terms of a percentage. The examined result value converted as such is firstly re-converted into examination marks resulted from the estimation by the internet stock exchange market. Then, the re-converted examination marks are converted in terms of a ratio with respect to the examination value resulted from the estimation by the professional examining group and are applied to a final estimation standard value.

3. The Examination Step by the Professional Examining Group

The professional examining group consists of professionals in the same business world and an estimation group of an insurance company. The data supplied to the professional examining group on the movie requested to be publicly-offered is identical to the data to be supplied upon examination by the internet stock exchange market. On the other hand, a standard of judgment of the professional examining group consists of ten steps more subdivided than that of the internet stock exchange market. Further, it is calculated along with the weighting factor in Table 1 and presented as a final standard value in the same way as the examining standard of the internet stock exchange market. The estimation group of the insurance company decides insurance rates in an insurance contract that will be made later, using the examination standard values of the netizens, the internet stock exchange market and the professional examining group.

On the other hand, the examination standard value of the professional examining group makes up about 50% of the final examination standard value and is equally applied since the examined items thereof are identical to those of the internet stock exchange market.

The examination standard values of the internet stock exchange market and the professional examining group are calculated according to the their ratios applied to the final estimation standard value. That is, if the examination standard values of the netizens, the internet stock exchange market and the professional examining group are 78.4, 87.5 and 80.5, respectively, the final estimation standard value becomes 81.17 in the above manner. The final estimation standard value determined as such is implemented according to each of the applied steps of Table 3, so that 100% of an expected production cost may be supplied.

When the examination standard value is obtained via the three examinations as aforementioned, an amount invested is settled according to the calculation table of Table 3. The amount invested is determined based on the ratios with respect to the production costs shown in Table 1. Further, the insurance rates are determined according to the examination standard value, and since the amount invested according to Table 3 may be varied depending on the work to be produced, the amount invested and the distribution of the publicly-subscribed stocks in addition to the examination standard value are also applied to the insurance rates.

As described above, the estimation standard value shown in Table 3 is determined with the ratios of the examination standard values, for example, 30% by the netizens, 20% by the internet stock exchange market and 50% by the professional examining group. The estimation standard value is reported on the homepage of the internet stock exchange market and is used for investigating the response by netizens to the reported result.

TABLE 3

| Estimation Standard Value | Amount invested |
|---|---|
| ˜59 | Rejection |
| 60˜69 | 60% of production costs |
| 70˜79 | 80% of production costs |
| 80˜ | 100% of production costs |

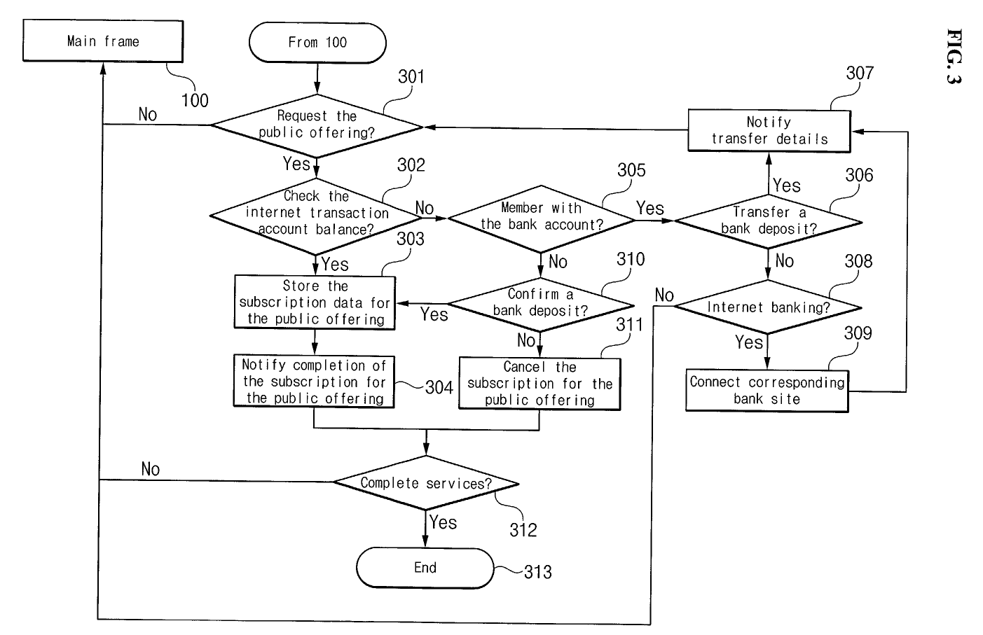

FIG. 3 shows a flow of the steps of subscribing for the public offering for a general investor according to the present invention.

Only when the general investor is a registered member like a public offering requester, the general investor can be connected with a step of subscribing for the public offering (block 301) via a main frame (100) by ID inputted in the course of log-in. The step of subscribing for the public offering includes the steps of being connected with the homepage of the internet stock exchange market through a web browser by the registered member; carrying out log-in measures into the main frame using the ID and password of the member; selecting one of the publicly-offered movies on the main frame; confirming information on the status of the public offering of the selected movie, a current offering price, and the like; and selecting a quantity and a supplying method of the publicly-subscribed stocks for the selected movie which the member intends to purchase.

The general investor passing the step of subscribing for the public offering (block 301) confirms whether there is a sufficient balance at the internet transaction account (block 302). If the balance at the internet transaction account should be lacking, whether the investor is a member of a bank account is confirmed (block 305). If the investor is a member of a bank account, whether money is transferred from the initially registered correspondent bank to the internet transaction account is confirmed (block 306). Upon approval of the investor, the direct transaction is established between the correspondent bank and the internet stock exchange market, and then, the investor is informed of the transfer particulars (block 307). If the investor selects banking facilities other than the correspondent bank registered through the internet banking (block 308), the connection with the internet site of the selected banking facilities is established (block 309) and the investor is informed of the transfer particulars (block 307). Thereafter, it is stored as data on the subscription for the public offering in a main server of the internet stock exchange market (block 303), and then, the investor is informed of the completion of the subscription for the public offering (block 304).

On the other hand, if the investor is not a member of a bank account, the investor subscribes for the public offering through a payment method such as giro, etc. After the confirmation of the payment, it is stored as data on the subscription for the public offering in the main server of the internet stock exchange market (block 303). Then, as described above, the investor is informed of the completion of the subscription for the public offering (block 304), and thus, the step of subscribing for the public offering is terminated.

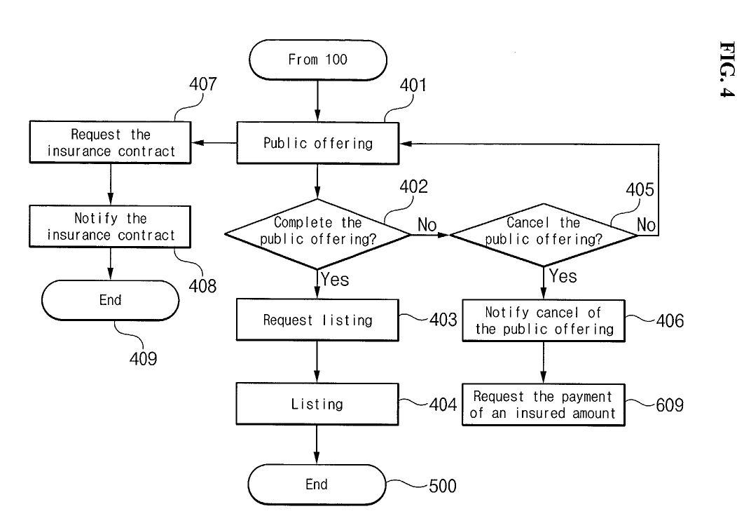

FIG. 4 shows a step of supporting the production costs for the work requested to be publicly-offered according to the steps in FIG. 2 through the public offering in the internet stock exchange market (hereinafter, referred to as “public offering step”).

The public offering step is also connected from the main frame (100), and the work requested to be publicly-offered is publicly-offered in the internet stock exchange market (block 401) while being covered by insurance through an insurance company (block 407). The internet stock exchange market informs the investor that the work is covered by insurance (block 408). At this time, the insurance contract is established using the insurance rates determined upon examination of the public offering as described above.

The public offering of the publicly-subscribed stocks is made over a certain period of time (block 401). The completed, publicly-subscribed stocks are listed on all kinds of stock markets in the internet stock exchange market (block 404) via a step of requesting the listing of stocks (block 403). For example, the movies are listed on a movie stock market.

The database used for the public offering step consists of the following contents:

A code table for the current publicly-offered movies.

An estimation standard value and expected insurance rates of the current publicly-offered movies.

An offering price, an expected listing price and a current trading volume of the stocks for the publicly-offered movies.

An amount of money to be publicly-offered and a management account.

All these data are provided in real time and monitored by an inspection organization such as the Securities Supervisory Board.

On the other hand, when in the course of the public offering, the publicly-offered amount of money from a general investor does not reach production costs, the investment of the existing movie company may be invited. When the public offering is withdrawn (block 405), the investor is informed of the withdrawal of the public offering (block 406) and the payment of an insured amount is requested (block 609).

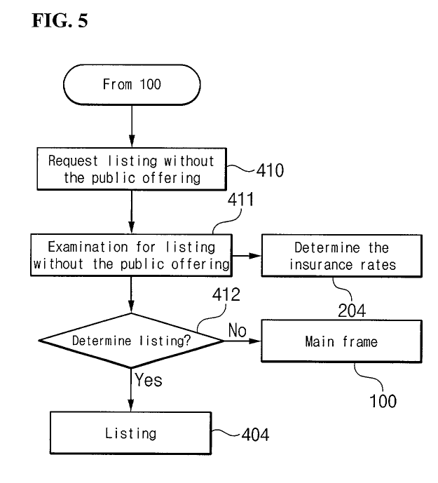

FIG. 5 is a flowchart showing the steps of listing non-publicly-offered movies (block 404).

In case of previously produced or imported movies which are not shown, since the production stage is not needed, one among them which is not publicly-offered is handled as a non-publicly-offered movie and requested to be listed on the movie stock market without the public offering (block 410). As for the requested movie to be listed without the public offering, the determination to list it (block 412) and the confirmation of the insurance rates (block 204) are made via a step of examining a request for listing of the movie without the public offering by an examining group comprised of netizens, the person in charge, and an insurance company (block 411) in the same way as the examination of public offering (block 203). Then, the movie is listed on the movie stock market (block 404).

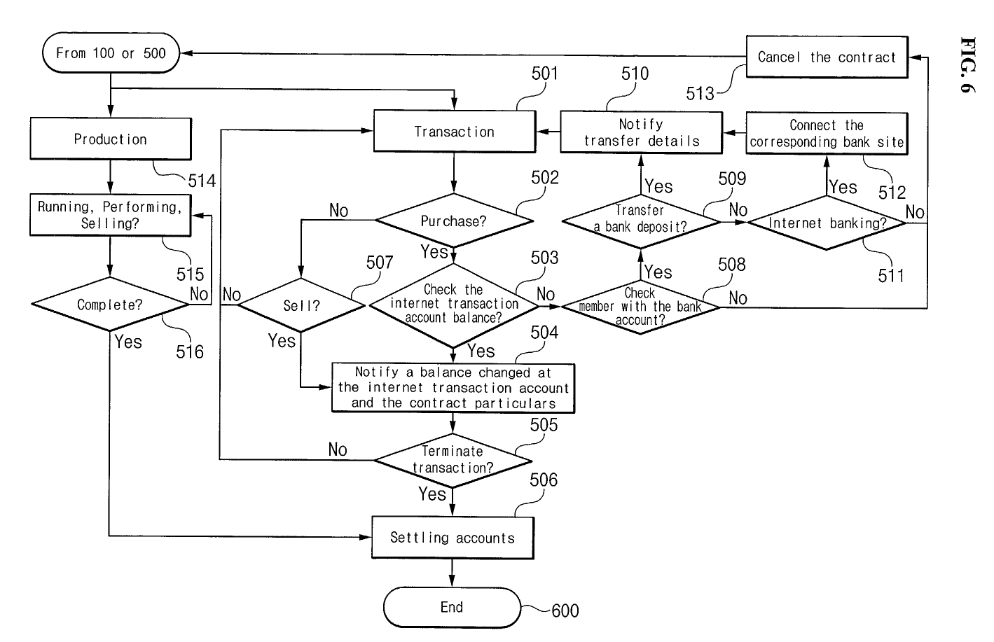

FIG. 6 is a flowchart showing the procedures of producing and transacting the listed movie.

The publicly-offered movie enters its production (block 514) from the listing thereof (block 404). That is, the production of the movie is carried out during the listing thereof. At this time, the money obtained by the public offering is used for the production costs, and the produced movie is shown during the listing thereof. On terminating the showing of the movie or distributing a video tape of the movie, the procedure proceeds into a step of settling accounts (block 506). The previously produced or imported movies are transacted while being subject only to the procedures except for the production stage (block 514) (the costs paid upon importing the movies are used like the production costs). Although such steps according to the present invention are similar to the existing public offering, they are clearly distinguished in terms of the ability of continuous conversion into money by a transaction concept which will be described later.

The publicly-subscribed stocks passing the main frame (100) or the listing step are transacted on the movie stock market while the work is produced, shown or performed. The transaction is continuously made until the accounts of the listed publicly-subscribed stocks are settled. This embodiment will be described based on the purchase (block 502). An investor who requests a purchase transaction (block 502) or an approved member for the transaction of the movie stocks confirms the balance of his transaction account (block 503) and pays the price with his internet transaction account in the internet stock exchange market. The purchaser is informed of a balance changed at the internet transaction account and the contract particulars (block 504). On the other hand, upon selling it, the seller is informed of a balance at the internet transaction account and the contract particulars for a profit obtained by the sale thereof (block 504) and thus, the steps of its purchase and sale are terminated (block 505).

On the other hand, upon purchasing it, if the balance at the internet transaction account lacks, it is confirmed as to whether the purchaser is a member of a bank account (block 508), so that the money from the registered correspondent bank account is transferred to the internet transaction account and then the purchaser is informed of the transfer particulars (block 510). If an account of a bank facility other than the registered correspondent bank is used, the connection with the site of the corresponding bank facility is made (block 512) and the money therefrom is transferred to the internet transaction account through the internet banking (block 511). Then, the purchaser is informed of the transaction particulars (block 510).

This transaction is completed upon termination of the showing of the movie or distribution of a video tape of the movie, and then, the procedure proceeds into the step of settling accounts (block 506), as described above. Although the steps of this transaction is similar to that of a general stock transaction, they are very different from each other in that the transaction of the present invention can be made while producing the movies or the like.

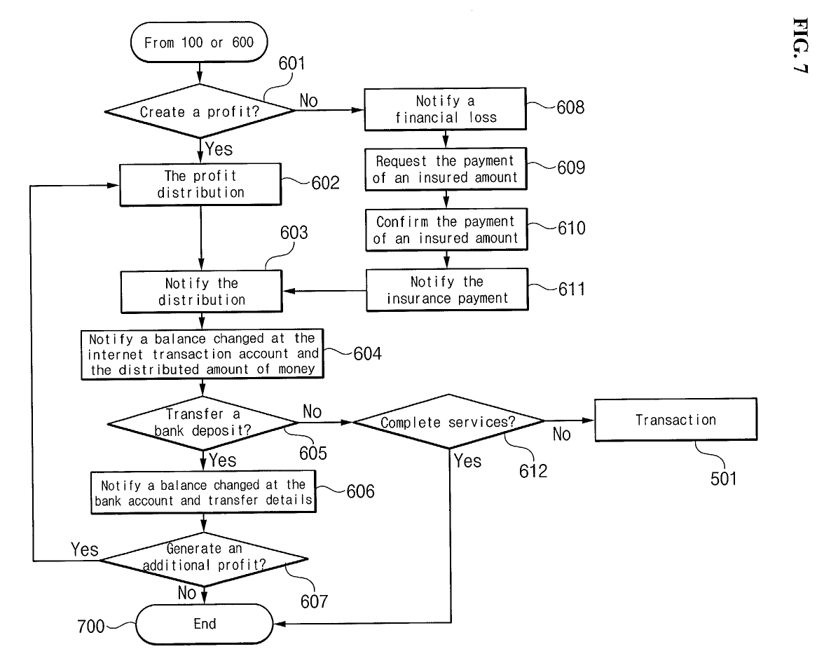

FIG. 7 shows a step of distributing a profit after the settlement of accounts in this embodiment.

The distribution of the profit continuously proceeds after the step of settling accounts (block 506). When the profit is generated (block 601) after the settlement of accounts (block 506), the profit is distributed according to the holding of stocks (block 602) and a final stockholder is informed of the distribution of the profit (block 603). After the notice of the distribution (block 603), the stockholder is informed of the distributed amount of money and the balance varying particulars at the internet transaction account (block 604) and it is confirmed as to whether the distributed amount of money will be transferred to the registered correspondent bank account (block 605). If the transfer of the distributed amount of money to the registered correspondent bank account is selected, the stockholder is informed of the variation of the balance at the registered correspondent bank account and of the transfer particulars. At this time, if the transfer of the distributed amount of money to the registered correspondent bank account is not selected, the distributed amount of money remains at the internet transaction account, and then, the service is terminated.

On the other hand, if there is no creation of profit (block 601), the final stockholder is informed of a financial loss (block 608), the contracted insurance company is requested to confirm the supply of the insurance money (block 610) through the step of requesting the supply of the insurance money (block 609), and the stockholder is informed of the receipt of the supplied insurance money (block 612). The steps thereafter are identical to the profit distributing manner as described above.

In the meantime, if there is further profit, for example, a further profit generated from the distribution of video tapes of the movie or the export of the movie after the distribution of the initial profit, the further profit is distributed. The final stockholder is also informed of the distributed amount of money and the balance varying particulars at the internet transaction account (block 604) after the notice of the distribution (block 603) via the step of distributing the profit (block 602), and then, the distributed amount of money is transferred to the registered correspondent bank account. Through the above ways, all the steps of the transaction of the publicly-subscribed stocks are completed.

Although the present invention has been described with reference to the publicly-offered movie stocks, it can be applied to the production of a record and an event.

What is claimed is:

1. A method for transacting publicly-offered culture stocks using the internet, having a membership obtainment step for transactions, a public offering step and a stock listing step, comprising:
a membership obtainment step for providing a member with an internet transaction account by which said member can make an investment and a purchase;
a public offering and examining step wherein an examining group including an insurance company determines whether a work requested by a public offering requester will be publicly-offered, and insurance rates are determined;
a public offering step for requesting said public offering of said examined work via an internet stock exchange market for publicly-subscribed culture stocks and for being covered by insurance;
a listing step for listing said publicly-subscribed culture stocks of said publicly-offered work on a stock market in said internet stock exchange market at the end of a public offering term;
a transaction step for transacting said listed, publicly-subscribed culture stocks until settlement of accounts, after listing of said stocks; and
a distribution step for distributing the full profit, after said settlement of accounts.

2. The method as claimed in claim 1, wherein in said public offering and examining step, a decision is made by a group comprised of netizens, a person in charge and said insurance company with estimation standard values and an amount invested and insurance rates are determined based on said estimation standard values.

3. The method as claimed in claim 1, further including a re-distributing step for distributing a further generated profit to a final stockholder of said publicly-subscribed culture stocks after said distribution of the initial profit.

4. The method as claimed in any one of claims 1 to 3, wherein said internet stock exchange market is an internet stock exchange market for publicly-subscribed stocks via said internet, where registered bonds in various forms other than a form of publicly-subscribed stocks of a general bearer bond are transacted, operating and investment funds required for production of said work other than a form of a general enterprise are supplied as assets (bonds), said whole issued bonds become the objects to be transacted, a producer of said work can always transact said transaction bonds since said transaction bonds itself supply the costs such as production costs and publicity costs upon production of said work, said assets are transferred to said internet transaction account immediately after transaction of said bonds, and said total profits are shared upon paying a dividend from actual results.
